(19) United States
(12) Patent Application Publication
(10) Pub. No.: US 2024/0338921 A1
(43) Pub. Date: Oct. 10, 2024

(54) Triggering a Visual Search in an Electronic Device

(71) Applicant: Apple Inc., Cupertino, CA (US)

(72) Inventors: Peter Burgner, Venice, CA (US); Paulo R Jansen dos Reis, San Jose, CA (US); Michael R Alger, Mountain View, CA (US)

(21) Appl. No.: 18/626,729

(22) Filed: Apr. 4, 2024

Related U.S. Application Data
(60) Provisional application No. 63/518,839, filed on Aug. 10, 2023.
(60) Provisional application No. 63/494,904, filed on Apr. 7, 2023.

(51) Int. Cl. G06V 10/22; G06V 20/50

(52) U.S. Cl. CPC G06V 10/225; G06V 20/50

(57) ABSTRACT

A head-mounted device may be paired with an external electronic device such as a cellular telephone. The head-mounted device may be used to perform visual searches. In some cases, a user provides input directly to the head-mounted device to trigger a visual search and the visual search is performed without any input or communication from the external electronic device. Alternatively, the external electronic device may be used to trigger a visual search performed by the head-mounted device, may serve as an optical marker to indicate a target region for the physical search, and/or may present content associated with the visual search performed by the head-mounted device. The external electronic device may use sensor data to detect a user's intent for a visual search and wirelessly transmit a visual search trigger to the head-mounted device.

This application claims the benefit of U.S. provisional patent application No. 63/518,839 filed Aug. 10, 2023, and U.S. provisional patent application No. 63/494,904 filed Apr. 7, 2023, which are hereby incorporated by reference herein in their entireties.

### BACKGROUND

This relates generally to electronic devices, and, more particularly, to electronic devices with cameras.

Some electronic devices such as head-mounted devices use cameras to perform visual searches on nearby physical objects. However, it may be difficult to distinguish which physical object is the target of a visual search.

### SUMMARY

An electronic device may include one or more sensors, one or more processors, and memory storing instructions configured to be executed by the one or more processors, the instructions for obtaining, via a first subset of the one or more sensors, sensor data for a physical environment, identifying, using the sensor data, an external electronic device in the physical environment, and selecting a subset of the physical environment for a visual search based on a position of the external electronic device in the physical environment.

An electronic device may include one or more sensors, one or more displays, one or more processors, and memory storing instructions configured to be executed by the one or more processors, the instructions for obtaining, via a first subset of the one or more sensors, sensor data, based on the sensor data, transmitting a visual search trigger to a head-mounted device, after transmitting the visual search trigger to the head-mounted device, receiving visual search information from the head-mounted device, and presenting, using the one or more displays, content associated with the visual search information.

### BRIEF DESCRIPTION OF THE DRAWINGS

FIG. 1 is a schematic diagram of an illustrative system including a head-mounted device and an electronic device in accordance with some embodiments.

FIG. 2A is a view of a physical object through an illustrative display of an electronic device in accordance with some embodiments.

FIG. 2B is a view of a physical object and visual search results associated with the physical object presented on an illustrative display of an electronic device in accordance with some embodiments.

FIG. 3 is a flowchart showing an illustrative method for operating a head-mounted device that performs a visual search and presents content associated with the visual search in accordance with some embodiments.

FIG. 4A is a view of a physical environment including a head-mounted device, an additional electronic device resting on a surface, and a physical object in accordance with some embodiments.

FIG. 4B is a view of a physical environment including a head-mounted device, an additional electronic device being viewed by the user of the head-mounted device, and a physical object in accordance with some embodiments.

FIG. 4C is a view of a physical environment including a head-mounted device, a physical object, and an additional electronic device being used to trigger a visual search of the physical object in accordance with some embodiments.

FIG. 5 is a view through an illustrative display in an electronic device of an additional electronic device triggering a visual search in accordance with some embodiments.

FIG. 6 is a flowchart showing an illustrative method for operating an electronic device that transmits a visual search trigger to a head-mounted device in accordance with some embodiments.

FIG. 7 is a flowchart showing an illustrative method for operating a head-mounted device that performs a visual search based on information regarding an additional electronic device in accordance with some embodiments.

FIG. 8 is a flowchart showing an illustrative method for operating an electronic device that transmits a visual search trigger to a head-mounted device based on one or more button presses in accordance with some embodiments.

FIG. 9A is a view of an illustrative physical environment while a first hand holds an additional electronic device adjacent to a second hand holding a physical object in accordance with some embodiments.

FIG. 9B is a view of an illustrative physical environment while a first hand holds an additional electronic device adjacent to a second hand pointing to a physical object in accordance with some embodiments.

FIG. 10 is a flowchart showing an illustrative method for operating a head-mounted device that triggers a visual search in accordance with some embodiments.

### DETAILED DESCRIPTION

Head-mounted devices may display different types of extended reality content for a user. The head-mounted device may display a virtual object that is perceived at an apparent depth within the physical environment of the user. Virtual objects may sometimes be displayed at fixed locations relative to the physical environment of the user. For example, consider an example where a user's physical environment includes a table. A virtual object may be displayed for the user such that the virtual object appears to be resting on the table. As the user moves their head and otherwise interacts with the XR environment, the virtual object remains at the same, fixed position on the table (e.g., as if the virtual object were another physical object in the XR environment). This type of content may be referred to as world-locked content (because the position of the virtual object is fixed relative to the physical environment of the user).

Other virtual objects may be displayed at locations that are defined relative to the head-mounted device or a user of the head-mounted device. First, consider the example of virtual objects that are displayed at locations that are defined relative to the head-mounted device. As the head-mounted device moves (e.g., with the rotation of the user's head), the virtual object remains in a fixed position relative to the head-mounted device. For example, the virtual object may be displayed in the front and center of the head-mounted device (e.g., in the center of the device's or user's field-of-view) at a particular distance. As the user moves their head left and right, their view of their physical environment changes accordingly. However, the virtual object may remain fixed in the center of the device's or user's field of view at the particular distance as the user moves their head (assuming gaze direction remains constant). This type of content may be referred to as head-locked content. The head-locked content is fixed in a given position relative to the head-mounted device (and therefore the user's head which is supporting the head-mounted device). The head-locked content may not be adjusted based on a user's gaze direction. In other words, if the user's head position remains constant and their gaze is directed away from the head-locked content, the head-locked content will remain in the same apparent position.

Second, consider the example of virtual objects that are displayed at locations that are defined relative to a portion of the user of the head-mounted device (e.g., relative to the user's torso). This type of content may be referred to as body-locked content. For example, a virtual object may be displayed in front and to the left of a user's body (e.g., at a location defined by a distance and an angular offset from a forward-facing direction of the user's torso), regardless of which direction the user's head is facing. If the user's body is facing a first direction, the virtual object will be displayed in front and to the left of the user's body. While facing the first direction, the virtual object may remain at the same, fixed position relative to the user's body in the XR environment despite the user rotating their head left and right (to look towards and away from the virtual object). However, the virtual object may move within the device's or user's field of view in response to the user rotating their head. If the user turns around and their body faces a second direction that is the opposite of the first direction, the virtual object will be repositioned within the XR environment such that it is still displayed in front and to the left of the user's body. While facing the second direction, the virtual object may remain at the same, fixed position relative to the user's body in the XR environment despite the user rotating their head left and right (to look towards and away from the virtual object).

In the aforementioned example, body-locked content is displayed at a fixed position/orientation relative to the user's body even as the user's body rotates. For example, the virtual object may be displayed at a fixed distance in front of the user's body. If the user is facing north, the virtual object is in front of the user's body (to the north) by the fixed distance. If the user rotates and is facing south, the virtual object is in front of the user's body (to the south) by the fixed distance.

Alternatively, the distance offset between the body-locked content and the user may be fixed relative to the user whereas the orientation of the body-locked content may remain fixed relative to the physical environment. For example, the virtual object may be displayed in front of the user's body at a fixed distance from the user as the user faces north. If the user rotates and is facing south, the virtual object remains to the north of the user's body at the fixed distance from the user's body.

Body-locked content may also be configured to always remain gravity or horizon aligned, such that head and/or body changes in the roll orientation would not cause the body-locked content to move within the XR environment. Translational movement may cause the body-locked content to be repositioned within the XR environment to maintain the fixed distance from the user. Subsequent descriptions of body-locked content may include both of the aforementioned types of body-locked content.

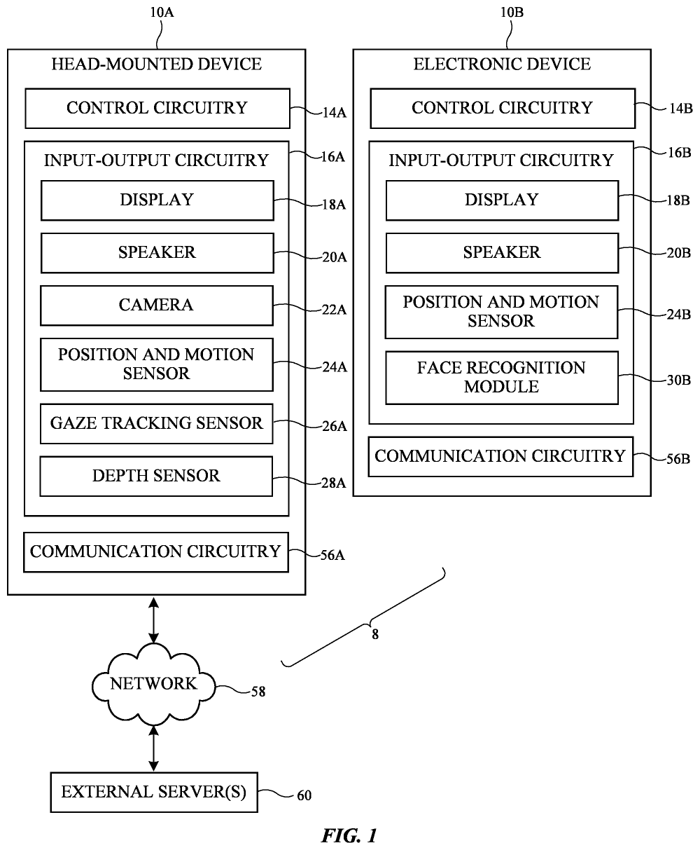

A schematic diagram of an illustrative system having a head-mounted device and an electronic device is shown in FIG. 1. As shown in FIG. 1, system 8 may include one or more electronic devices such as electronic device 10A and electronic device 10B. The electronic devices of system 8 may include computers such as laptop computers, cellular telephones, head-mounted devices, wristwatch devices, tablet computers, earbuds, and other electronic devices. Configurations in which electronic device 10A is a head-mounted device and electronic device 10B is a cellular telephone are described herein as an example.

As shown in FIG. 1, electronic device 10A (sometimes referred to as head-mounted device 10A, system 10A, head-mounted display 10A, etc.) may have control circuitry 14A. In addition to being a head-mounted device, electronic device 10A may be other types of electronic devices such as a cellular telephone, laptop computer, speaker, computer monitor, electronic watch, tablet computer, etc. Control circuitry 14A may be configured to perform operations in head-mounted device 10A using hardware (e.g., dedicated hardware or circuitry), firmware and/or software. Software code for performing operations in head-mounted device 10A and other data is stored on non-transitory computer readable storage media (e.g., tangible computer readable storage media) in control circuitry 14A. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14A. The processing circuitry may include application-specific integrated circuits with processing circuitry, one or more microprocessors, digital signal processors, graphics processing units, a central processing unit (CPU) or other processing circuitry.

Head-mounted device 10A may include input-output circuitry 16A. Input-output circuitry 16A may be used to allow a user to provide head-mounted device 10A with user input. Input-output circuitry 16A may also be used to gather information on the environment in which head-mounted device 10A is operating. Output components in circuitry 16A may allow head-mounted device 10A to provide a user with output.

As shown in FIG. 1, input-output circuitry 16A may include a display such as display 18A. Display 18A may be used to display images for a user of head-mounted device 10A. Display 18A may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18A may be an opaque display that blocks light from physical objects when a user operates head-mounted device 10A. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18A is opaque, the display may also optionally display entirely computer-generated content (e.g., without displaying images of the physical environment).

Display 18A may include one or more optical systems (e.g., lenses) (sometimes referred to as optical assemblies) that allow a viewer to view images on display(s) 18A. A single display 18A may produce images for both eyes or a pair of displays 18A may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Input-output circuitry 16A may include various other input-output devices. For example, input-output circuitry 16A may include one or more speakers 20A that are configured to play audio and/or one or more microphones that are configured to capture audio data from the user and/or from the physical environment around the user.

Input-output circuitry 16A may include one or more cameras 22A. Cameras 22A may include one or more outward-facing cameras (that face the physical environment around the user when the electronic device is mounted on the user's head, as one example). Cameras 22A may capture visible light images, infrared images, or images of any other desired type. The cameras may be stereo cameras if desired. Outward-facing cameras may capture pass-through video for device 10. Cameras 22A may also include inward-facing cameras (e.g., for gaze detection).

As shown in FIG. 1, input-output circuitry 16A may include position and motion sensors 24A (e.g., compasses, gyroscopes, accelerometers, and/or other devices for monitoring the location, orientation, and movement of electronic device 10, satellite navigation system circuitry such as Global Positioning System circuitry for monitoring user location, etc.). Using sensors 24A, for example, control circuitry 14A can monitor the current direction in which a user's head is oriented relative to the surrounding environment (e.g., a user's head pose). The cameras in cameras 22A may also be considered part of position and motion sensors 24A. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16A may include a gaze-tracking sensor 26A (sometimes referred to as gaze-tracker 26A, gaze-tracking system 26A, gaze detection sensor 26A, etc.). The gaze-tracking sensor 26A may include a camera and/or other gaze-tracking sensor components (e.g., light sources that emit beams of light so that reflections of the beams from a user's eyes may be detected) to monitor the user's eyes. Gaze-tracker 26A may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 26A is merely illustrative.

Input-output circuitry 20 may include one or more depth sensors 28A. Each depth sensor may be a pixelated depth sensor (e.g., that is configured to measure multiple depths across the physical environment) or a point sensor (that is configured to measure a single depth in the physical environment). Each depth sensor (whether a pixelated depth sensor or a point sensor) may use phase detection (e.g., phase detection autofocus pixel(s)) or light detection and ranging (LIDAR) to measure depth. Camera images (e.g., from one of cameras 22) may also be used for monocular and/or stereo depth estimation. Any combination of depth sensors may be used to determine the depth of physical objects in the physical environment.

Input-output circuitry 16A may also include other sensors and input-output components if desired (e.g., ambient light sensors, force sensors, temperature sensors, touch sensors, buttons, capacitive proximity sensors, light-based proximity sensors, other proximity sensors, strain gauges, gas sensors, pressure sensors, moisture sensors, magnetic sensors, audio components, haptic output devices such as actuators and/or vibration motors, light-emitting diodes, other light sources, etc.).

Head-mounted device 10A may also include communication circuitry 56A to allow the head-mounted device to communicate with external equipment (e.g., a tethered computer, a portable device such as electronic device 10B, one or more external servers, or other electrical equipment). Communication circuitry 56A may be used for both wired and wireless communication with external equipment.

Communication circuitry 56A may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56A may handle wireless local area network (WLAN) communications bands such as the 2.4 GHZ and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHZ), a cellular low-midband (LMB) (e.g., 1400 to 1550 MHZ), a cellular midband (MB) (e.g., from 1700 to 2200 MHZ), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHZ (e.g., 3G bands, 4G LTE bands, 5G New Radio Frequency Range 1 (FR1) bands below 10 GHz, etc.), a near-field communications (NFC) band (e.g., at 13.56 MHZ), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHZ and/or a second UWB communications band at 8.0 GHZ), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Ku communications band between about 12 GHZ and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHZ), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56A may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10A may use communication circuitry 56A to communicate with one or more external servers 60 through network(s) 58. Examples of communication network(s) 58 include local area networks (LAN) and wide area networks (WAN) (e.g., the Internet). Communication network(s) 58 may be implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol.

External server(s) 60 may be implemented on one or more standalone data processing apparatus or a distributed network of computers. External server 60 may provide information such as visual search information to head-mounted device 10A (via network 58) in response to information from head-mounted device 10A.

Head-mounted device 10A may communicate with external server(s) 60 to obtain visual search information. For example, the head-mounted device may, in response to user input, send a visual search request to external server(s) 60. The visual search request may include various information for identifying a physical object near the head-mounted device (e.g., within the field-of-view of the user). The information transmitted by the head-mounted device for identifying a physical object may include images from one or more cameras on the head-mounted device, feature point information, depth information, and/or other desired information. The external server(s) may compare the received information to a database and identify if there is a match to a physical object in the database. When there is a match, the external server(s) may send information regarding the physical object (sometimes referred to as visual search information) to the head-mounted device. The head-mounted device may then present content to the user based on the visual search information.

The example of communicating with external server(s) 60 to conduct a visual search is merely illustrative. If desired, head-mounted device 10A may perform a visual search using information stored on the head-mounted device 10A (e.g., in memory of control circuitry 14A).

Electronic device 10B may be paired with electronic device 10A. In other words, a wireless link may be established between electronic devices 10A and 10B to allow fast and efficient communication between devices 10A and 10B. Electronic devices 10A and 10B may be associated with the same user (e.g., signed into a cloud service using the same user ID), may exchange wireless communications, etc. As previously described, electronic device 10A may be a head-mounted device whereas electronic device 10B is a paired electronic device such as a cellular telephone, watch, laptop computer, earbuds, etc.

Electronic device 10B may include control circuitry 14B, input-output circuitry 16B, display 18B, speaker 20B, position and motion sensors 24B, face recognition module 30B, and communication circuitry 56B. Control circuitry 14B, input-output circuitry 16B, display 18B, speaker 20B, position and motion sensors 24B, and communication circuitry 56B may have the same features and capabilities as the corresponding components in electronic device 10A and, for simplicity, the descriptions thereof will not be repeated. It is noted that display 18B may include an organic light-emitting diode display or other displays based on arrays of light-emitting diodes, a liquid crystal display, a liquid-crystal-on-silicon display, a projector or display based on projecting light beams on a surface directly or indirectly through specialized optics (e.g., digital micromirror devices), an electrophoretic display, a plasma display, an electrowetting display, or any other desired display.

Face recognition module 30B may include a flood illuminator, a speckle illuminator, and an image sensor. The image sensor (sometimes referred to as an inward-facing image sensor) may be positioned to capture images in front of electronic device 10B. For example, the image sensor may be positioned to capture images of the user (e.g., the user's face) while the user views display 18B and operates electronic device 10B. The inward-facing image sensor may be, for example, an array of sensors. Sensors in the sensor array may include, but not be limited to, charge coupled device (CCD) and/or complementary metal oxide semiconductor (CMOS) sensor elements to capture infrared images (IR) or other non-visible electromagnetic radiation. The image sensor may detect light at an infrared wavelength such as a wavelength in the range of 800-1100 nanometers (e.g., 940 nanometers). In some embodiments, the face recognition module may include more than one image sensor to capture multiple types of images (e.g., both an infrared image sensor and a visible light sensor that senses red, blue, and green light may be included).

The flood illuminator may include an infrared light source (e.g., a laser, lamp, infrared light-emitting diode, an array of vertical-cavity surface-emitting lasers (VCSELs), etc.). The flood illuminator may provide constant and/or pulsed illumination at an infrared wavelength such as a wavelength in the range of 800-1100 nanometers (e.g., 940 nanometers). For example, the flood illuminator may provide flood infrared (IR) illumination to flood a subject with IR illumination (e.g., an IR flashlight). The flood infrared illumination comprises diffused infrared light that uniformly covers a given area. The inward-facing image sensor may capture images of the flood IR illuminated subject. The captured images may be, for example, two-dimensional images of the subject illuminated by IR light.

The speckle illuminator may include an infrared light source (e.g., a laser, lamp, infrared light-emitting diode, an array of vertical-cavity surface-emitting lasers (VCSELs), etc.). The speckle illuminator may provide constant and/or pulsed illumination at an infrared wavelength such as a wavelength in the range of 800-1100 nanometers (e.g., 940 nanometers). For depth detection or generating a depth map image, the speckle illuminator may provide IR illumination with a speckle pattern. The speckle pattern (sometimes referred to as structured light) may be a pattern of collimated light spots (e.g., a pattern of dots) with a known, and controllable, configuration and pattern projected onto a subject. The speckle illuminator may include a vertical-cavity surface-emitting laser (VCSEL) array configured to form the speckle pattern or a light source and patterned layer configured to form the speckle pattern. The configuration and pattern of the speckle pattern provided by the speckle illuminator may be selected, for example, based on a desired speckle pattern density (e.g., dot density) at the subject. The inward-facing image sensor may capture images of the subject illuminated by the speckle pattern. The captured image of the speckle pattern on the subject may be assessed (e.g., analyzed and/or processed) by an imaging and processing system (ISP) to produce or estimate a three-dimensional map of the subject (e.g., a depth map or depth map image of the subject).

The components of face recognition module 30B may be used to confirm whether or not a user is an authorized user of the electronic device. For example, control circuitry 14B within the electronic device may unlock the electronic device if face recognition module 30B confirms the person viewing the electronic device is an authorized user for the electronic device. Control circuitry 14B within the electronic device may not unlock the electronic device if face recognition module 30B determines that the person viewing the electronic device is not an authorized user for the electronic device.

In the event that electronic device 10B is a cellular telephone or tablet computer, electronic device 10B may have a housing and display 18B may form a front face of the electronic device within the housing. In the event that electronic device 10B is a watch, electronic device 10B may have a housing, display 18B may form a front face of the electronic device within the housing, and a wristwatch strap may extend from first and second opposing sides of the housing. In the event that electronic device 10B is a laptop computer, electronic device 10B may have a lower housing with a keyboard and/or touchpad and an upper housing with a display. The lower housing and the upper housing may be coupled at a hinge such that the upper housing rotates relative to the lower housing to open and close the laptop computer.

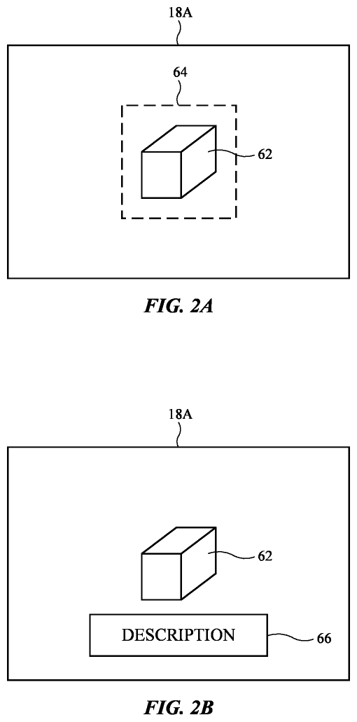

Head-mounted device 10A may be used to perform visual searches on physical objects in the physical environment around the head-mounted device. FIG. 2A is a view of a physical object 62 as seen through display 18A in head-mounted device 10A. While viewing physical object 62 through display 18A, a user may request a visual search (e.g., by providing user input to a microphone and/or button). In response to the request for the visual search, head-mounted device 10A may perform a visual search (e.g., on area 64 in FIG. 2A).

In FIG. 2B, head-mounted device 10A presents a description 66 of the physical object 62 on display 18A after performing the visual search. In addition to a description of the physical object, the head-mounted device may present web content associated with the physical object identified in the visual search or application-specific content associated with the physical object identified in the visual search.

As an example, a user may be looking at a houseplant and provide user input to trigger a visual search. As an example of user input to trigger the visual search, the user may ask an audible question about the type of houseplant being viewed. The question is detected by a microphone in the head-mounted device. In response, a visual search may be performed using images of the houseplant captured by the head-mounted device. The visual search may identify the type of houseplant and the head-mounted device may subsequently display the name of the type of houseplant and a description of the houseplant. Web content associated with the visual search may also be presented. Examples of web content include a link to the website of a store that sells the particular houseplant, a link to a website that describes how to care for the particular houseplant, etc.

As another example, a user may be looking at a business card and trigger a visual search. During the visual search, the business card and associated contact information may be identified (e.g., using optical character recognition). After performing the visual search, the head-mounted device may present a contact with information from the business card already filled into the appropriate data fields of the contact. The user may then choose to add the contact to their list of contacts.

As another example, a user may be looking at a poster for a concert and trigger a visual search. During the visual search, the poster and information associated with the concert may be identified (e.g., using optical character recognition). After performing the visual search, the head-mounted device may present a calendar entry with information from the poster filled into the appropriate data fields. The user may then choose to add the event to their calendar.

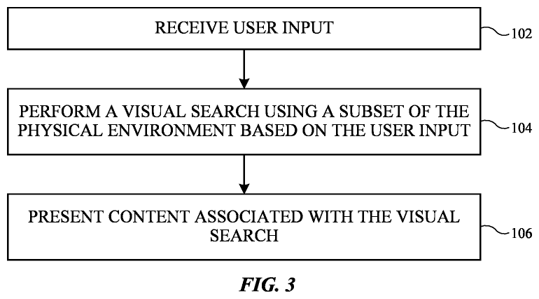

FIG. 3 is a flowchart showing illustrative method blocks for operating a head-mounted device that performs a visual search. At block 102, the head-mounted device may receive user input that triggers the visual search. The user input may include audio input (e.g., a voice command), a button press, gaze-based input, etc.

At block 104, the head-mounted device 10A may perform a visual search using a subset of the physical environment based on the user input. The head-mounted device 10A may select the subset of the physical environment for the visual search using gaze detection information (e.g., the user may tend to search an area that is overlapped by their point of gaze), head pose information (e.g., the user may tend to search an area that is centered in their field of view), depth information (e.g., by identifying physical objects in a normal depth range for visual searches), images from one or more cameras, etc.

At block 106, the head-mounted device 10A may present content associated with the visual search. The presented content may include a description of a physical object identified in the visual search, web content associated with a physical object identified in the visual search, application-specific content associated with a physical object identified in the visual search (e.g., a calendar entry, a contact, etc.), and/or other content.

In the example of FIGS. 2A, 2B, and 3, the visual search is performed using head-mounted device 10A without any input or communication from electronic device 10B. This example is merely illustrative. If desired, electronic device 10B may be used to trigger a visual search performed by head-mounted device 10A, may serve as an optical marker to indicate a target region for the physical search, and/or may present content associated with the visual search performed by head-mounted device 10A.

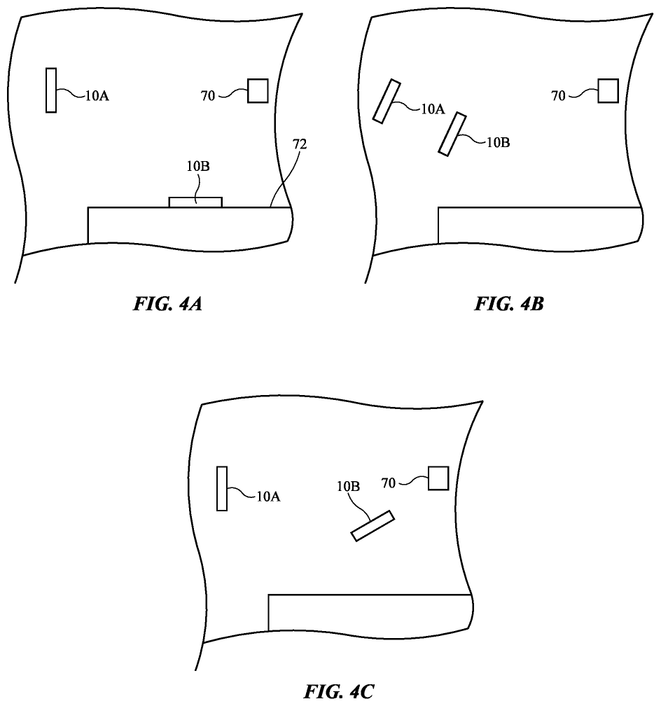

FIGS. 4A-4C show a view of a physical environment that includes a head-mounted device 10A (e.g., that is worn by a user on their head), an electronic device 10B (e.g., a cellular telephone), and a physical object 70. Electronic devices 10A and 10B are paired and belong to a common user. In FIG. 4A, electronic device 10B rests on surface 72 (e.g., a table). In FIG. 4B, the user has picked up electronic device 10B to view electronic device 10B (e.g., through a transparent display on head-mounted device 10A). In FIG. 4C, the user uses electronic device 10B to trigger a visual search on physical object 70.

The gesture to trigger a visual search (which is shown in FIG. 4C) may include extending electronic device 10B away from the user such that the physical object is positioned above the top of electronic device 10B. Said another way, the user points electronic device 10B at the physical object of interest or taps electronic device 10B to the physical object of interest.

In response to detecting the gesture in FIG. 4C, electronic device 10B may transmit a visual search trigger to head-mounted device 10A. Head-mounted device 10A then performs a visual search on an area adjacent to the top of the electronic device 10B (as determined using one or more cameras in head-mounted device 10A). In other words, in addition to triggering the visual search in electronic device 10A, electronic device 10B serves as a visual indicator for a region that is desired to be searched.

Electronic device 10B may serve as a visual search trigger to head-mounted device 10A even without explicitly wirelessly transmitting a visual search trigger to head-mounted device 10A. Head-mounted device 10A may monitor the physical environment, may recognize electronic device 10B, and may detect the electronic device 10B performing a gesture to trigger a visual search. Head-mounted device 10A therefore may perform the visual search based on the gesture by electronic device 10B even without directly communicating with electronic device 10B.

One or more sensors in electronic device 10B may be used to detect a user input that serves as a trigger for a visual search. In the example of FIG. 4C, an accelerometer or other position and motion sensor 24B is used to detect a gesture that triggers the visual search. Other inputs to electronic device 10B may be used to trigger the visual search if desired.

One or more sensors in electronic device 10B may be used to avoid false positives in triggering a visual search. As shown in FIG. 4B, a common gesture that is used with electronic device 10B is raising electronic device 10B to view electronic device 10B. This type of raise-to-wake gesture may also be identified as a visual search request gesture. Electronic device 10B may treat a raise-to-wake gesture as equivalent to a visual search request gesture or may attempt to distinguish between a raise-to-wake gesture and a visual search request gesture. In either case, to avoid a raise-to-wake gesture undesirably triggering a visual search, face recognition module 30B in electronic device 10B may be used. In particular, face recognition module 30B may check if the user's face is viewing and/or in front of electronic device 10B. If the user is viewing electronic device 10B, the detected gesture is likely for the scenario in FIG. 4B that should not trigger a visual search. If the user is not viewing electronic device 10B, the detected gesture is likely for triggering a visual search as in FIG. 4C.

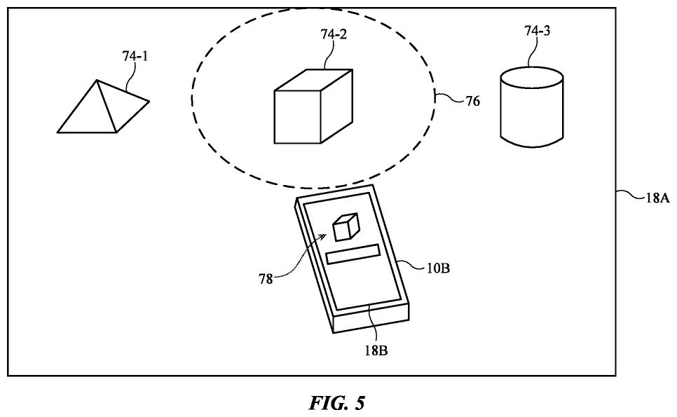

FIG. 5 is a view through an illustrative display in an electronic device of an additional electronic device triggering a visual search in accordance with some embodiments. In FIG. 5, a user has performed a visual search gesture (e.g., extending electronic device 10B to point to a physical object) that triggers a visual search request. Head-mounted device 10A (with display 18A) receives the visual search request from electronic device 10B and, using images from cameras 22A, confirms that electronic device 10B has a pose consistent with the visual search request.

Head-mounted device 10A may use electronic device 10B as a visual indicator for a region 76 upon which to perform the visual search. Region 76 for the visual search may be adjacent to electronic device 10B. More specifically, region 76 may be adjacent to the top of electronic device 10B (or the side of electronic device 10B that is furthest from head-mounted device 10A). The visual indicator of the position of electronic device 10B may allow head-mounted device 10A to discriminate between multiple physical objects for potential visual search. In FIG. 5, for example, there are three physical objects 74-1, 74-2, and 74-3 that all are candidates for a visual search. However, the position of electronic device 10B adjacent to physical object 74-2 identifies physical object 74-2 as the target for the visual search.

In FIGS. 2B and 3, an example was described where content associated with the visual search results is presented on display 18A of head-mounted device 10A. This example is merely illustrative. When electronic device 10B is used to trigger the visual search, content 78 associated with the visual search may instead be presented on display 18B of electronic device 10B. The presented content 78 on display 18B may include an image of the identified physical object, a description of the identified physical object, web content associated with the identified physical object, a notification associated with the identified physical object, application-specific content associated with the identified physical object, etc.

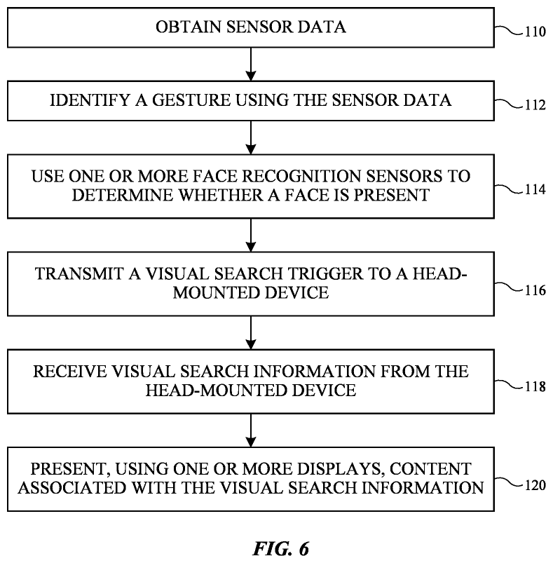

FIG. 6 is a flowchart showing an illustrative method for operating an electronic device that transmits a visual search trigger to a head-mounted device. As shown, at block 110, electronic device 10B may obtain sensor data. The sensor data may include, as an example, data from one or more position and motion sensors 24B.

At block 112, the electronic device 10B may identify a gesture using the sensor data. The identified gesture may be a motion gesture in which the electronic device 10B is extended away from the user. Instead or in addition, the pose of the electronic device 10B may be used to identify an intent to trigger a visual search from the user. When a visual search is intended, the pose of electronic device 10B may tend to be more horizontal than when viewed by a user who is standing or sitting upright. There may be a pose or a range of poses that are associated with an intent to trigger a visual search.

It is noted that a combination of two or more inputs/gestures may be identified at block 112 (and used to trigger a visual search). For example, the identified gesture(s) may include both a motion gesture in which the electronic device 10B is extended away from the user and a touch input where a user swipes a touch-sensitive display on electronic device 10B (e.g., swipes the display from top to bottom or from bottom to top). Using two or more inputs/gestures to trigger a visual search may mitigate false positives (where a visual search is triggered without the user intending to do so).

At block 114, electronic device 10B may use one or more face recognition sensors (e.g., from face recognition module 30B) to determine whether a face is present in front of electronic device 10B. If a face is present in front of electronic device 10B, the user is likely not intending to trigger a visual search and therefore no further action may be taken to verify/trigger the visual search request. If a face is not present in front of electronic device 10B, the user is likely intending to trigger a visual search and therefore the method may proceed to block 116.

At block 116, electronic device 10B may transmit a visual search trigger (sometimes referred to as a visual search request) to a paired head-mounted device 10A. The visual search trigger may be transmitted wirelessly (e.g., using Bluetooth communications or other desired communications) or through a wired connection (if available).

If desired, one or more images from a camera on electronic device 10B may also be transmitted to the head-mounted device 10A at block 116. The images from the camera on electronic device 10B may be used by head-mounted device 10A for the visual search.

At block 118, electronic device 10B may receive visual search information from the head-mounted device 10A. The visual search information may be received wirelessly (e.g., using Bluetooth communications or other desired communications) or through a wired connection (if available). The visual search information may include information identifying a physical object, a description of the identified physical object, web content associated with the identified physical object, a notification associated with the identified physical object, application-specific content associated with the identified physical object, an image of the identified physical object, etc.

At block 120, electronic device 10B may present, using display 18B, content associated with the visual search information received at block 118. Accordingly, at block 120 display 18B may present information identifying a physical object, a description of the identified physical object, web content associated with the identified physical object, a notification associated with the identified physical object, application-specific content associated with the identified physical object, an image of the identified physical object, etc.

At block 120, information such as a notification may be presented even if electronic device 10B is operating in a focus mode in which some or all other notifications are suppressed. In other words, the user's intentional triggering of the visual search may override the focus mode. The user may configure these options in settings as desired.

When a notification is presented at block 120, the notification may identify a visual search result without providing details regarding the content of the visual search results. At a later time when the user desires, the user may view the notification and take appropriate action based on the visual search result.

FIG. 6 shows an example where content associated with the visual search information is presented during the operations of block 120. It is further noted that before and/or during the operations of block 120, electronic device 10B may present, using display 18B, an icon or other visual indicator that indicates to the user that the visual search is ongoing. As an example, display 18B may begin displaying the visual indicator associated with the ongoing visual search after identifying the gesture(s) during the operations of block 112. The visual indicator may continue to be presented on display 18B during the operations of blocks 114, 116, and 118.

Display 18B may cease presenting the visual indicator during the operations of block 120 or may present the visual indicator simultaneously with the visual search information during the operations of block 120. The visual indicator may have any desired appearance and may occupy any desired portion(s) of display 18B.

It is noted that the sensor data obtained at block 110 may be continuously obtained during operation of electronic device 10B. For example, accelerometer data may be obtained and monitored even when electronic device 10B is in a standby mode. The accelerometer data may be used to detect a raise-to-wake gesture. Because the accelerometer is obtained by electronic device 10B to detect a raise-to-wake gesture, there is little additional power consumption required to also monitor for the visual search gesture.

Additionally, identifying false positives of the visual search gesture using the face recognition module in electronic device 10B mitigates power consumption in head-mounted device 10A by preventing unnecessary visual search triggers that would otherwise increase power consumption in head-mounted device 10A.

Consider an example where electronic device 10B is a cellular telephone. The user may wish to perform a visual search on a business card that an acquaintance is holding for them to view. At block 110, an accelerometer in the cellular telephone is used to obtain sensor data. The user picks up their cellular telephone and extends the cellular telephone away from their body with a relatively horizontal pose to point at the business card. Accordingly, at block 112 the accelerometer and/or other sensors may detect a gesture (e.g., a visual search gesture). At block 114, the face recognition module 30B in cellular telephone 10B may verify if a user is actively viewing the cellular telephone. Since the user is holding the cellular telephone away from their body and with a relatively horizontal pose, a viewer is not detected. The method therefore proceeds to block 116, where the cellular telephone wirelessly transmits a visual search trigger to a paired head-mounted device 10A that is being worn by the user. The cellular telephone subsequently receives visual search information from the head-mounted device at block 118. The received visual search information may include information identifying a business card as the physical object being searched as well as contact information (e.g., name, telephone numbers, and email addresses) included in the business card as determined using optical character recognition. At block 120, the cellular telephone displays a notification regarding the identified business card. The notification may be maintained on the cellular telephone until the user selects the notification. When the user selects the notification, the user may be presented with an option to add a contact based on the contact information identified in the business card.

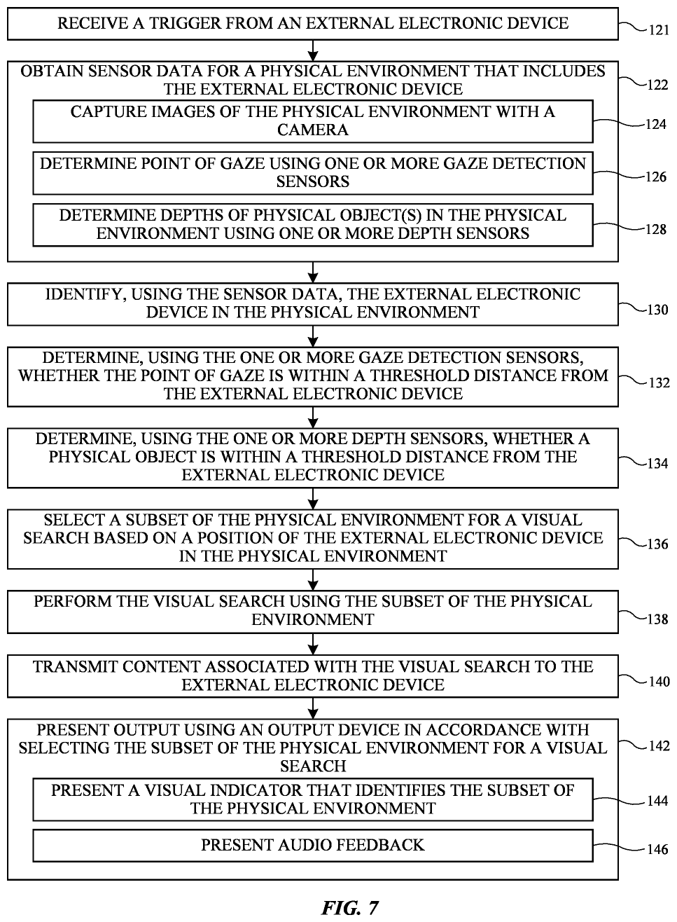

FIG. 7 is a flowchart showing an illustrative method for operating a head-mounted device that performs a visual search based on information regarding an additional electronic device. First, at block 121, the head-mounted device 10A may receive a trigger from an external electronic device. As one example, the trigger from the external electronic device may be a visual search request that is received wirelessly (e.g., using Bluetooth communications). The example of receiving the trigger from the external electronic device is merely illustrative. Alternatively, user input to head-mounted device 10A (e.g., audio input such as a voice command, one or more button presses, gaze-based input, etc.) may be used to trigger the visual search.

At block 122, head-mounted device 10A may obtain sensor data for a physical environment that includes the external electronic device. In general, head-mounted device 10A captures data at block 122 in response to the trigger at block 121 or the data captured at block 122 may be captured regardless of whether or not a trigger is received. A sensor that is off (powered down) may be turned on to capture data at block 122 in response to the trigger. The sampling rate of a sensor may be increased at block 122 in response to the trigger.

As shown in FIG. 7, obtaining the sensor data may include capturing images of the physical environment using a camera 22A at block 124, determining point of gaze using one or more gaze detection sensors 26A at block 126, and determining the depth of one or more physical objects in the physical environment using one or more depth sensors 28A at block 128.

At block 130, head-mounted device 130 may identify, using the sensor data from block 122, the external electronic deice in the physical environment. The external electronic device may be identified using the captured images from camera 22A at block 124 and/or depth information from block 128.

At block 132, head-mounted device 10A may determine, using one or more gaze detection sensors 26A, whether the point of gaze is within a threshold distance from external electronic device 10B. If the point of gaze is within the threshold distance, the head-mounted device 10A may assume that the user is intending to perform a visual search on a subset of the physical environment that is near the electronic device 10B. If the point of gaze is not within the threshold distance, the head-mounted device 10A may assume that the user is not intending to perform a visual search and therefore foregoes the visual search.

At block 134, head-mounted device 10A may determine, using one or more depth sensors 28A, whether a physical object is within a threshold distance from the external electronic device in the physical environment. If there is a physical object within the threshold distance, the head-mounted device 10A may determine that the user is intending to perform a visual search on a subset of the physical environment that includes the physical object. If there is not a physical object within the threshold distance, the head-mounted device 10A may determine that the user is not intending to perform a visual search and therefore foregoes the visual search and/or may display a notification to the user stating, “No candidate for visual search found,” or other similar text.

At block 136, head-mounted device 10A may select a subset of the physical environment for a visual search based on the position of the external electronic device in the physical environment. The selected subset of the physical environment may be adjacent to the electronic device 10B. More particularly, the selected subset of the physical environment may be adjacent to the top of electronic device 10B (or the side of electronic device 10B that is furthest from head-mounted device 10A).

Also at block 136, a user's point of gaze may be used to select the subset of the physical environment for the visual search. For example, the subset of the physical environment for the visual search may include the point of gaze.

Also at block 136, the depth information regarding physical objects relative to electronic device 10B may be used to select the subset of the physical environment for the visual search. For example, the subset of the physical environment for the visual search may include the physical object with the closest depth to the depth of the electronic device 10B.

Also at block 136, information from position and motion sensors 24A may be used to select the subset of the physical environment for the visual search. For example, the subset of the physical environment for the visual search may be centered in the field-of-view of the user based on the head pose determined using position and motion sensors 24A.

At block 138, head-mounted device 10A may perform the visual search using the subset of the physical environment. The head-mounted device 10A may use images captured by cameras 22A to perform the visual search. Instead or in addition, the head-mounted device 10A may optionally use one or more images captured by a camera in electronic device 10B to perform the visual search. The images may be analyzed and compared to a database that is stored on head-mounted device 10A and/or a database on one or more external servers 60. Optical character recognition (OCR) may be performed when text is identified in the subset of the physical environment. The visual search may therefore identify one or more physical objects in the subset of the physical environment, may identify and recognize text in the subset of the physical environment, etc.

At block 140, head-mounted device 10A may transmit content associated with the visual search to external electronic device 10B. The transmitted content may include information identifying a physical object, a description of the identified physical object, web content associated with the identified physical object, a notification associated with the identified physical object, application-specific content associated with the identified physical object, an image of the identified physical object, etc.

At block 142, head-mounted device 10A may optionally present output using an output device in accordance with selecting the subset of the physical environment for a visual search. Presenting output may include presenting a visual indicator that identifies the subset of the physical environment as in block 144. The visual indicator may be a reticle that is aligned with the subset of the physical environment, as one example. The reticle may be a world-locked reticle that is fixed to the subset of the physical environment. Presenting output may also include presenting audio feedback as in block 146. The audio feedback may include, for example, a chime that indicates to the user that the visual search is being performed.

If desired, block 142 may be omitted and head-mounted device 10A does not provide any explicit output to the user regarding the visual search (other than transmitting information to electronic device 10B to be presented using electronic device 10B).

In one example, display 18A of head-mounted device 10A does not present any visual content associated with the visual search when the visual search is triggered by electronic device 10B. In contrast, display 18A of head-mounted device 10A does present visual content associated with the visual search (e.g., as in FIGS. 2B and 3) when the visual search is triggered by user input (e.g., a voice command to a microphone or a button press) to head-mounted device 10A.

It is noted that, if desired, block 121 may be omitted from the method of FIG. 7. Even if head-mounted device 10A does not receive a visual search request from electronic device 10B, head-mounted device 10A may identify electronic device 10B in the physical environment, may identify a gesture performed by electronic device 10B, and/or may use the position of electronic device 10B to select a subset of the physical environment for a visual search. Head-mounted device 10A may use images from camera 22A and/or depth information from depth sensors 28A to recognize a visual search gesture by electronic device 10B and/or a pose of electronic device 10B that is associated with an intent for visual search.

Consider an example where electronic device 10B is a cellular telephone. The user may wish to perform a visual search on a business card that an acquaintance is holding for them to view. The user picks up their cellular telephone and extends the cellular telephone away from their body with a relatively horizontal pose to point at the business card. This causes the cellular telephone to transmit a visual search trigger that is received by head-mounted device 10A at block 121. In response to receiving the visual search trigger at block 121, head-mounted device 10A turns on (or increases the sampling rate of) cameras 22A at block 124, gaze detection sensors 26A at block 126, and depth sensors 28A at block 128. At block 130, head-mounted device 10A identifies the cellular telephone 10B in the physical environment using sensor data from camera 22A and/or depth sensors 28A. Head-mounted device 10A may identify a gesture associated with an intent for visual search and/or may recognize a pose of cellular telephone 10B that is associated with an intent for visual search. At block 132, head-mounted device 10A may confirm that the point of gaze is within a threshold distance from cellular telephone 10B (consistent with the intent for visual search). At block 134, head-mounted device 10A may confirm that a physical object is within a threshold distance of cellular telephone 10B (consistent with the intent for visual search). At block 136, head-mounted device 10A selects a subset of the physical environment for the visual search based on a position of cellular telephone 10B within the physical environment. The selected subset of the physical environment may be adjacent to a top of cellular telephone 10B, aligned with the user's point of gaze, and may include a physical object within a threshold distance of cellular telephone 10B. At block 138, head-mounted device 10A performs the visual search using the subset of the physical environment. At block 140, head-mounted device 10A wirelessly transmits content associated with the visual search to cellular telephone 10B. At block 142, head-mounted device plays an audio chime to provide an affirmation to the user that the visual search is proceeding.

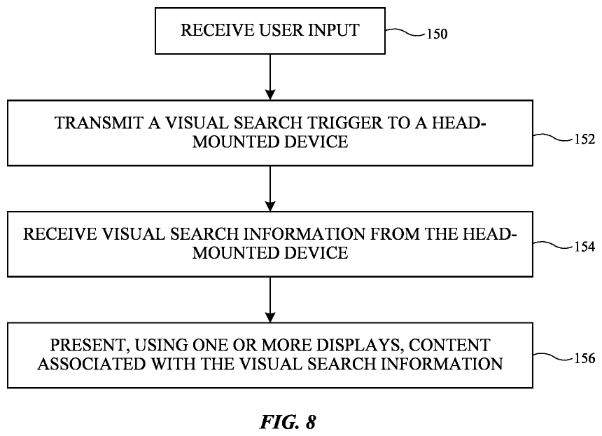

In the example of FIG. 6, an electronic device transmits a visual search trigger to a head-mounted device in response to sensor data (e.g., a motion gesture and/or pose detected using the sensor data). This example is merely illustrative. FIG. 8 is a flowchart showing an illustrative method for operating an electronic device that transmits a visual search trigger to a head-mounted device in response to a user input such as a button press.

During the operations of block 150, electronic device 10B may receive user input. The user input may include, as one example, one or more button presses that are associated with a user's intent to perform a visual search using head-mounted device 10A.

The one or more button presses may include one or more button presses on only a single button. For example, the single button may be pressed once (sometimes referred to as a single press or single click) to indicate a user's intent to perform a visual search, may be pressed twice (sometimes referred to as a double press or double click) to indicate a user's intent to perform a visual search, may be pressed three times (sometimes referred to as a triple press or triple click) to indicate a user's intent to perform a visual search, may be pressed and held for a given duration of time (e.g., at least 1 second, at least 2 seconds, at least 3 seconds, etc.) to indicate a user's intent to perform a visual search, etc.

The one or more button presses may include one or more button presses on two or more buttons. For example, two or more buttons may be pressed in a given sequence to indicate a user's intent to perform a visual search, two or more buttons may be pressed simultaneously to indicate a user's intent to perform a visual search, etc.

In general, any combination of short presses and long presses on one or more buttons in electronic device 10B may be set to serve as an indicator that the user wants to perform a visual search using the head-mounted device 10B. Each button that obtains user input at block 150 may also be used for other functions in electronic device 10B (e.g., adjusting the volume up or down, powering the display on or off, etc.).

The example of one or more button presses being used as the user input that indicates a user's intent to perform a visual search is merely illustrative. In general, any other desired user input (e.g., touch input to a touch-sensitive display, an audio command detected using a microphone in electronic device 10B, etc.) may be used to indicate a user's intent to perform a visual search.

The operations of block 152 are similar to the operations of block 116 in FIG. 6. At block 152, electronic device 10B may transmit a visual search trigger (sometimes referred to as a visual search request) to a paired head-mounted device 10A in response to the user input (e.g., one or more button presses) at block 150. The visual search trigger may be transmitted wirelessly (e.g., using Bluetooth communications or other desired communications) or through a wired connection (if available). If desired, one or more images from a camera on electronic device 10B may also be transmitted to the head-mounted device 10A at block 152. The images from the camera on electronic device 10B may be used by head-mounted device 10A for the visual search.

Using user input such as button presses to cause the transmission of the visual search trigger (as in blocks 150 and 152) may mitigate false positives in performing the visual search. The one or more button presses may optionally be used in combination with any other sensor data to cause the transmission of the visual search trigger at block 152.

The operations of block 154 are similar to the operations of block 118 in FIG. 6. At block 154, electronic device 10B may receive visual search information from the head-mounted device 10A. The visual search information may be received wirelessly (e.g., using Bluetooth communications or other desired communications) or through a wired connection (if available). The visual search information may include information identifying a physical object, a description of the identified physical object, web content associated with the identified physical object, a notification associated with the identified physical object, application-specific content associated with the identified physical object, an image of the identified physical object, etc.

The operations of block 156 are similar to the operations of block 120 in FIG. 6. At block 156, electronic device 10B may present, using display 18B, content associated with the visual search information received at block 154. Accordingly, at block 156 display 18B may present information identifying a physical object, a description of the identified physical object, web content associated with the identified physical object, a notification associated with the identified physical object, application-specific content associated with the identified physical object, an image of the identified physical object, etc.

At block 156, information such as a notification may be presented even if electronic device 10B is operating in a focus mode in which some or all other notifications are suppressed. In other words, the user's intentional triggering of the visual search may override the focus mode. The user may configure these options in settings as desired.

When a notification is presented at block 156, the notification may identify a visual search result without providing details regarding the content of the visual search results. At a later time when the user desires, the user may view the notification and take appropriate action based on the visual search result.

The order of blocks in FIGS. 6-8 is merely illustrative and the blocks may be performed in different orders if desired. Moreover, one or more blocks may be omitted from FIGS. 6-8 if desired.

Examples have been described above where a motion gesture by electronic device 10B triggers a visual search by head-mounted device 10A. It should be understood that the visual search may optionally be performed by electronic device 10B instead of head-mounted device 10A. As an example, head-mounted device 10A may capture images using camera 22A and transmit the images to electronic device 10B in response to a visual search being triggered. Electronic device 10B may use the images from camera 22A to identify a subset of the images (e.g., a particular physical object) for the visual search and subsequently perform the visual search using the subset of the images.

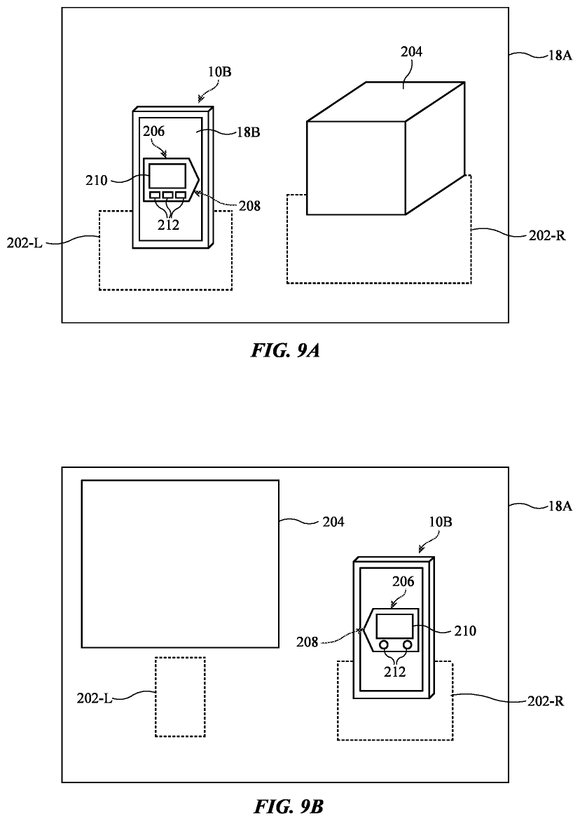

The example of a motion gesture by electronic device 10B triggering a visual search is merely illustrative. Other input to head-mounted device 10A and/or electronic device 10B may be used to trigger a visual search. One example of an additional visual search trigger is a user holding electronic device 10B in one hand and a physical object in a second hand in close proximity to the electronic device. FIG. 9A is a view of a physical environment when this type of trigger occurs.

As shown in FIG. 9A, electronic device 10B may be held by a first hand 202-L (e.g., a left hand) of the user of devices 10A/10B and a physical object 204 may be held by a second hand 202-R (e.g., a right hand) of the user of devices 10A/10B. Camera 22A in head-mounted device 10A may capture images identifying that electronic device 10B and physical object 204 are both being held by the user in close proximity to one another (e.g., within two feet of one another, within one foot of one another, within six inches of one another, etc). In response to identifying that electronic device 10B and physical object 204 are both being held by the user in close proximity to one another, a visual search may be performed. The physical object being held next to the electronic device may be the subject of the visual search.

One or more steps associated with the visual search (e.g., identifying the object for the visual search and performing the visual search) may optionally be performed by electronic device 10B instead of head-mounted device 10A. In a first example, HMD 10A transmits the image(s) captured by camera 22 to electronic device 10B in response to HMD 10A identifying that electronic device 10B and physical object 204 are both being held by the user in close proximity to one another. Electronic device 10B subsequently identifies the object for the visual search and performs the visual search. In a second example, HMD 10A transmits the image captured by camera 22 and the selection of the object for the visual search to electronic device 10B in response to HMD 10A identifying that electronic device 10B and physical object 204 are both being held by the user in close proximity to one another. Electronic device 10B subsequently performs the visual search. One or both of devices 10A and 10B may present results associated with the visual search.

FIG. 9A shows an example where content 206 associated with the visual search is presented on display 18B. Content 206 may include a visual indicator 208 that points in the direction of the physical object being searched. The visual indicator 208 (sometimes referred to as an arrow or directional indicator) may confirm to the user the location of the physical object that is the subject of the visual search. The directional indictor may point left, right, up, down, or other intermediate directions if desired. Content 206 may include primary visual search results 210 and secondary visual search results 212. In general, there are multiple types of content that may be presented in response to a visual search. Consider an example where physical object 204 is a food item available for purchase in a grocery store. Visual search results presented on display 18B may optionally include nutrition facts for the food item, an ingredient list for the food item, reviews of the food item, links to recipes that include the food item, etc. Control circuitry 14B may select one of these types of search results to present as the primary visual search results 210. Affordances identifying the other types of search results may also be presented as secondary visual search results 212. The user may select one of the secondary visual search results 212 to see more details on that type of search result.

In some scenarios, a user may wish to perform a visual search on an object that is too large to hold in their hand. In these types of scenarios, an alternate visual search trigger may be used where a user points at a physical object while holding electronic device 10B near or in alignment with that physical object. A visual search trigger of this type is shown in FIG. 9B.

As shown in FIG. 9B, electronic device 10B may be held by the right hand 202-R of the user of devices 10A/10B and a physical object 204 may be pointed at by the left hand 202-L of the user of devices 10A/10B. Camera 22A in head-mounted device 10A may capture images identifying that electronic device 10B is being held by the user and the user is pointing to a physical object. In response to identifying that electronic device 10B is being held and the user is pointing at a physical object, a visual search may be performed. The physical object being pointed to may be the subject of the visual search.

Content 206 with the visual search results may be presented on display 18B similar to as shown and described in connection with FIG. 9A. In the example of FIG. 9B, physical object 204 is to the left of electronic device 10B so the directional indicator 208 points to the left (instead of the right as in FIG. 9A).

FIGS. 9A and 9B show the physical environment as viewed through display 18A on HMD 10A. However, it should be understood that the visual search triggers of FIGS. 9A and 9B may be used even when HMD 10A does not have a display. For example, HMD 10A may be glasses or headphones that include a camera but do not have a display. When HMD 10A does not have a display, the camera on the HMD may still detect the visual search trigger.

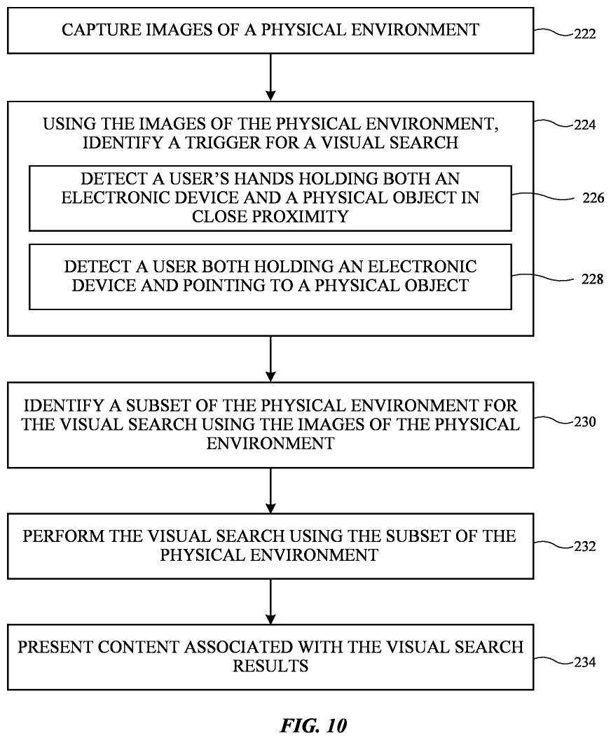

FIG. 10 is a flowchart showing an illustrative method for operating a system including an electronic device and a head-mounted device. During the operations of block 222, HMD 10A may capture images of a physical environment around the HMD using camera 22A. Next, during the operations of block 224, HMD 10A may identify a trigger for a visual search using the images of the physical environment from block 222. As shown by the operations of block 226, the trigger identified may include detecting, in the images of the physical environment from block 222, a user's hands holding both electronic device 10B and a physical object in close proximity (similar to as shown in FIG. 9A). As shown by the operations of block 228, the trigger identified may include detecting, in the images of the physical environment from block 222, a user both holding electronic device 10B and pointing to a physical object (similar to as shown in FIG. 9B).

After identifying the trigger for the visual search, devices 10A and/or 10B may, during the operations of block 230, identify a subset of the physical environment for the visual search using the images from block 222. Devices 10A and/or 10B may next, during the operations of block 232, perform the visual search using the subset of the physical environment identified at block 230. Finally, devices 10A and/or 10B may present content associated with the visual search results during the operations of block 234.

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An electronic device comprising:
one or more sensors;
one or more processors; and
memory storing instructions configured to be executed by the one or more processors, the instructions for:
obtaining, via a first subset of the one or more sensors, sensor data for a physical environment;
identifying, using the sensor data, an external electronic device in the physical environment; and
selecting a subset of the physical environment for a visual search based on a position of the external electronic device in the physical environment.

2. The electronic device defined in claim 1, wherein the instructions further comprise instructions for:
before identifying, using the sensor data, the external electronic device in the physical environment, receiving a trigger from the external electronic device;
performing the visual search using the subset of the physical environment; and
transmitting content associated with the visual search to the external electronic device.

3. The electronic device defined in claim 2, wherein obtaining the sensor data for the physical environment comprises obtaining the sensor data for the physical environment in response to receiving the trigger from the external electronic device and wherein the trigger is sent by the external electronic device in response to a gesture detected by the external electronic device or in response to an unsuccessful face recognition by the external electronic device.

4. The electronic device defined in claim 1, wherein the instructions further comprise instructions for:
obtaining, via a second subset of the one or more sensors, point of gaze information;
determining, using the point of gaze information, whether a point of gaze is within a threshold distance from the external electronic device; and
performing the visual search using the subset of the physical environment in accordance with a determination that the point of gaze is within the threshold distance from the external electronic device.

5. The electronic device defined in claim 1, wherein the instructions further comprise instructions for:
obtaining, via a third subset of the one or more sensors, depth information for the physical environment;
determining, using the depth information, whether a physical object is within a threshold distance from the external electronic device; and
performing the visual search using the subset of the physical environment in accordance with a determination that the physical object is within the threshold distance from the external electronic device.

6. The electronic device defined in claim 1, wherein the first subset of the one or more sensors comprises an outward-facing camera and wherein the electronic device further comprises:
one or more displays; and
one or more speakers, wherein the instructions further comprise instructions for:
presenting, using the one or more displays, a visual indicator that identifies the subset of the physical environment for the visual search; and
in response to selecting the subset of the physical environment for the visual search, presenting, using the one or more speakers, audio feedback.

7. The electronic device defined in claim 1, wherein identifying the external electronic device in the physical environment comprises identifying that the external electronic device is being held by a first hand while a physical object is being held by a second hand and wherein selecting the subset of the physical environment for the visual search comprises selecting the physical object for the visual search.

8. The electronic device defined in claim 1, wherein identifying the external electronic device in the physical environment comprises identifying that the external electronic device is being held by a first hand while a physical object is being pointed to by a second hand and wherein selecting the subset of the physical environment for the visual search comprises selecting the physical object for the visual search.

9. A method of operating an electronic device that comprises one or more sensors, the method comprising:
obtaining, via a first subset of the one or more sensors, sensor data for a physical environment;
identifying, using the sensor data, an external electronic device in the physical environment; and
selecting a subset of the physical environment for a visual search based on a position of the external electronic device in the physical environment

10. The method defined in claim 9, further comprising:
before identifying, using the sensor data, the external electronic device in the physical environment, receiving a trigger from the external electronic device;
performing the visual search using the subset of the physical environment; and
transmitting content associated with the visual search to the external electronic device.

11. The method defined in claim 10, wherein obtaining the sensor data for the physical environment comprises obtaining the sensor data for the physical environment in response to receiving the trigger from the external electronic device.

12. The method defined in claim 10, wherein the trigger is sent by the external electronic device in response to a gesture detected by the external electronic device or in response to an unsuccessful face recognition by the external electronic device.

13. The method defined in claim 9, further comprising:
obtaining, via a second subset of the one or more sensors, point of gaze information;
determining, using the point of gaze information, whether a point of gaze is within a threshold distance from the external electronic device; and
performing the visual search using the subset of the physical environment in accordance with a determination that the point of gaze is within the threshold distance from the external electronic device.

14. The method defined in claim 9, further comprising:
obtaining, via a third subset of the one or more sensors, depth information for the physical environment;
determining, using the depth information, whether a physical object is within a threshold distance from the external electronic device; and
performing the visual search using the subset of the physical environment in accordance with a determination that the physical object is within the threshold distance from the external electronic device.

15. The method defined in claim 9, wherein the first subset of the one or more sensors comprises an outward-facing camera.

16. The method defined in claim 9, wherein the electronic device further comprises one or more displays and one or more speakers and wherein the method further comprises:
presenting, using the one or more displays, a visual indicator that identifies the subset of the physical environment for the visual search; and
in response to selecting the subset of the physical environment for the visual search, presenting, using the one or more speakers, audio feedback.

17. A non-transitory computer-readable storage medium storing one or more programs configured to be executed by one or more processors of an electronic device that comprises one or more sensors, the one or more programs including instructions for:
obtaining, via a first subset of the one or more sensors, sensor data for a physical environment;
identifying, using the sensor data, an external electronic device in the physical environment; and
selecting a subset of the physical environment for a visual search based on a position of the external electronic device in the physical environment

18. The non-transitory computer-readable storage medium defined in claim 17, wherein the instructions further comprise instructions for:
before identifying, using the sensor data, the external electronic device in the physical environment, receiving a trigger from the external electronic device;
performing the visual search using the subset of the physical environment; and
transmitting content associated with the visual search to the external electronic device.

19. The non-transitory computer-readable storage medium defined in claim 18, wherein obtaining the sensor data for the physical environment comprises obtaining the sensor data for the physical environment in response to receiving the trigger from the external electronic device.

20. The non-transitory computer-readable storage medium defined in claim 18, wherein the trigger is sent by the external electronic device in response to a gesture detected by the external electronic device or in response to an unsuccessful face recognition by the external electronic device.

21. The non-transitory computer-readable storage medium defined in claim 17, wherein the instructions further comprise instructions for:
obtaining, via a second subset of the one or more sensors, point of gaze information;
determining, using the point of gaze information, whether a point of gaze is within a threshold distance from the external electronic device; and
performing the visual search using the subset of the physical environment in accordance with a determination that the point of gaze is within the threshold distance from the external electronic device.

22. The non-transitory computer-readable storage medium defined in claim 17, wherein the instructions further comprise instructions for:
obtaining, via a third subset of the one or more sensors, depth information for the physical environment;
determining, using the depth information, whether a physical object is within a threshold distance from the external electronic device; and
performing the visual search using the subset of the physical environment in accordance with a determination that the physical object is within the threshold distance from the external electronic device.

23. The non-transitory computer-readable storage medium defined in claim 17, wherein the first subset of the one or more sensors comprises an outward-facing camera.

24. The non-transitory computer-readable storage medium defined in claim 17, wherein the electronic device further comprises one or more displays and one or more speakers and wherein the instructions further comprise instructions for:
presenting, using the one or more displays, a visual indicator that identifies the subset of the physical environment for the visual search; and
in response to selecting the subset of the physical environment for the visual search, presenting, using the one or more speakers, audio feedback.
